(19) United States
(12) Patent Application Publication
(10) Pub. No.: US 2025/0286219 A1
(43) Pub. Date: Sep. 11, 2025

(54) COMPOSITE SEPARATOR AND SECONDARY BATTERY USING THE SAME

(71) Applicants: SK INNOVATION CO., LTD., Seoul (KR); SK IE TECHNOLOGY CO., LTD., Seoul (KR)

(72) Inventors: Yun Bong KIM, Daejeon (KR); Eun Ji OH, Daejeon (KR); Dong Jae KIM, Daejeon (KR); Hee Joon JUNG, Daejeon (KR); Kyu Young CHO, Daejeon (KR)

(21) Appl. No.: 19/076,141

(22) Filed: Mar. 11, 2025

(30) Foreign Application Priority Data
Mar. 11, 2024 (KR) 10-2024-0033696

(51) Int. Cl. H01M 50/446; H01M 10/052; H01M 50/417; H01M 50/42; H01M 50/434; H01M 50/443; H01M 50/449; H01M 50/489

(52) U.S. Cl. CPC H01M 50/446; H01M 10/052; H01M 50/417; H01M 50/42; H01M 50/434; H01M 50/443; H01M 50/449; H01M 50/489

(57) ABSTRACT

Composite separators and secondary batteries are disclosed. In an embodiment, a composite separator includes a porous substrate and an adhesive layer formed on an outermost layer of at least one surface of the porous separator. The adhesive layer includes first organic particles with a first average particle diameter (D50) and a first glass transition temperature and second organic particles with a second average particle diameter (D50) and a second glass transition temperature. The first glass transition temperature is lower than the second glass transition temperature, and the first average particle diameter is smaller than the second average particle diameter, and the first organic particles and the second organic particles satisfy a specific relation.

### CROSS-REFERENCE TO RELATED APPLICATIONS

This patent document claims the priority and benefits of Korean Patent Application No. 10-2024-0033696, filed on Mar. 11, 2024, the disclosure of which is incorporated herein by reference in its entirety.

### TECHNICAL FIELD

The technology and implementations disclosed in this patent document generally relate to a composite separator and a secondary battery including the same.

### BACKGROUND

In a secondary battery such as a lithium-ion battery, a separator is a thin, porous membrane placed between the negative electrode (anode) and the positive electrode (cathode) and is provided to prevent direct physical contact between two electrodes and to allow lithium ions to pass through, enabling the flow of the electric current within the battery while preventing short circuits. A separator can be made of a porous substrate or a high heat-resistant separator including a porous substrate and a porous ceramic layer (or an inorganic particle layer) formed on one or both sides of the porous substrate.

### SUMMARY

In an embodiment of the disclosed technology, a composite separator may include an adhesive layer formed on one surface or two opposite surfaces of a porous separator and including a particulate organic binder having specific physical properties, ensuring strong adhesion to an electrode while simultaneously preventing a blocking phenomenon when the winding process of the separator. The porous separator may be a porous separator formed of a porous substrate or a porous separator including a porous substrate and a porous ceramic layer formed on one surface or two opposite surfaces of the porous substrate.

In another embodiment of the disclosed technology, a composite separator maintains its initial adhesive force without degradation after being wound and unwound. In addition, the composite separator may prevent blocking and exhibit excellent heat resistance.

In another embodiment of the disclosed technology, the separator exhibits uniform lithium ion conductivity across the entire area of the separator.

In another embodiment of the disclosed technology, the composite separator exhibits excellent anti-blocking properties. The composite separator may prevent blocking between adhesive layers, between an adhesive layer and a ceramic layer, or between an adhesive layer and a porous substrate, in a wound roll, even when stored at a high temperature (e.g., 50 to 70° C.) as well as at room temperature (e.g., around 25° C.) during transport and storage of a wound separator.

In another embodiment of the disclosed technology, a composite separator can address the issues of the existing separators by preventing blocking when adhesive layers are brought into contact with each other, pressurized at a temperature of 50° C. and a pressure of 1.7 MPa for 2 hours, and then peeled at a speed of 300 mm/min and an angle of 180°.

In another embodiment of the disclosed technology, a separator exhibits excellent cell capacity retention. For example, in a lithium ion secondary battery using a separator based on an embodiment of the disclosed technology, the capacity retention rate remains at 85% or more, or 90% or more, after 300 cycles compared to the initial capacity.

The composite separator based on some embodiments of the disclosed technology and the secondary battery including the same may be widely applied in electric vehicles, battery charging stations, and other green technology fields, such as solar power generation and wind power generation using batteries. In addition, the composite separator based on some embodiments of the disclosed technology and the secondary battery including the same may be used in eco-friendly electric vehicles, hybrid vehicles, and others to prevent climate change by suppressing air pollution and greenhouse gas emissions.

In one general aspect, a composite separator for a secondary battery includes an adhesive layer formed on the outermost layer of at least one surface of a porous separator, wherein the adhesive layer includes first organic particles and second organic particles having different average particle diameters D50 and different glass transition temperatures, the first organic particles have a lower glass transition temperature and a smaller average particle diameter than the second organic particles, and the first organic particles and the second organic particles satisfy the following Relational Expression 1:

$$3 \leq {T}_{2} / {T}_{1} \times {R}_{2} / {R}_{1} \leq 8.5 \qquad [ Relational Expression 1 ]$$

wherein T₁ is the glass transition temperature (° C.) of the first organic particles, T₂ is the glass transition temperature (° C.) of the second organic particles, R₁ is the average particle diameter D50 (μm) of the first organic particles, and R₂ is the average particle diameter D50 (μm) of the second organic particles.

In an embodiment, the first organic particles may have a glass transition temperature of 90° C. or lower, and the second organic particles may have a glass transition temperature of 95° C. or higher.

In an embodiment, the first organic particles may have an average particle diameter of 100 to 1,000 nm, and the second organic particles may have an average particle diameter of 500 to 2,000 nm.

In an embodiment, the first organic particles may have a glass transition temperature of 90° C. or lower and an average particle diameter of 100 to 1,000 nm, and the second organic particles may have a glass transition temperature of 95° C. or higher and an average particle diameter of 500 to 2,000 nm, but the disclosed technology is not limited thereto.

In an embodiment, the first organic particles and the second organic particles may have a glass transition temperature difference of 5° C. or higher, but are not limited thereto.

In an embodiment, the average particle diameter of the second organic particles may be twice or more the average particle diameter of the first organic particles, but is not limited thereto.

In an embodiment, a content ratio of the first organic particles:the second organic particles may be a weight ratio of 50 to 99:50 to 1, but is not limited thereto.

In an embodiment, the first organic particles and the second organic particles may be acrylic-based organic particles.

In an embodiment, the porous separator may include a porous substrate; or a porous substrate and a porous ceramic layer being formed on one surface or both surfaces of a porous substrate and including inorganic particles.

In an embodiment, the inorganic particles of the porous ceramic layer may have an average particle diameter D50 of 50 nm to 2 μm, but are not limited thereto.

In an embodiment, the inorganic particles of the porous ceramic layer may include first inorganic particles having an average particle diameter D50 of 50 to 500 nm and second inorganic particles having an average particle diameter D50 of 500 to 2,000 nm, but are not limited thereto.

In an embodiment, the porous ceramic layer may have pores formed between the inorganic particles connected by a binder.

In an embodiment, the porous substrate may be a polyolefin-based porous film.

In an embodiment, the composite separator may have a thermal shrinkage of 3% or less in both a machine direction and a transverse direction when measured at 150° C. In an implementation, the machine direction refers to the direction that a material moves through a machine or is fed into a device, and the transverse direction refers to the direction perpendicular to the machine direction.

In one general aspect, a composite separator for a secondary battery, the composite separator comprising a porous separator, and an adhesive layer formed on an outermost layer of at least one surface of the porous separator, wherein the adhesive layer includes first organic particles with a first average particle diameter indicating that 50% of the first organic particles in the adhesive layer have smaller particle diameters and a first glass transition temperature and second organic particles with a second average particle diameter indicating that 50% of the second organic particles in the adhesive layer have smaller particle diameters and a second glass transition temperature, wherein the first glass transition temperature is lower than the second glass transition temperature, and the first average particle diameter is smaller than the second average particle diameter, and the first organic particles and the second organic particles satisfy the following Relational Expression 1:

$$3 \leq {T}_{2} / {T}_{1} \times {R}_{2} / {R}_{1} \leq 8.5 \qquad [ Relational Expression 1 ]$$

wherein T₁ is the first glass transition temperature in degrees Celsius (° C.), T₂ is the second glass transition temperature in degrees Celsius (° C.), R₁ is the first average particle diameter in micrometers (μm), and R₂ is the second average particle diameter in micrometers (μm).

In an embodiment, wherein the first glass transition temperature is 90° C. or lower, and the second glass transition temperature is 95° C. or higher, but the disclosed technology is not limited thereto.

In an embodiment, wherein the first average particle diameter ranges from 100 to 1,000 nm, and the second average particle diameter ranges from 500 to 2,000 nm, but the disclosed technology is not limited thereto.

In an embodiment, wherein the first glass transition temperature is 90° C. or lower and the first average particle diameter ranges from 100 to 1,000 nm, and the second glass transition temperature is 95° C. or higher and the second average particle diameter ranges from 500 to 2,000 nm, but the disclosed technology is not limited thereto.

In an embodiment, wherein a difference between the first glass transition temperature and the second glass transition temperature is 5° C. or higher, but the disclosed technology is not limited thereto.

In an embodiment, wherein the second average particle diameter is twice or more the first average particle diameter.

In an embodiment, wherein a content ratio of the first organic particles to the second organic particles calculated based on weight ranges from 50:50 to 99:1, but the disclosed technology is not limited thereto.

In an embodiment, wherein the first organic particles and the second organic particles include acrylic-based organic particles.

In an embodiment, wherein the porous separator includes a porous substrate or a porous ceramic layer, wherein the porous ceramic layer is formed on one surface or two opposite surfaces of a porous substrate and includes inorganic particles.

In an embodiment, wherein the inorganic particles of the porous ceramic layer have an average particle diameter D50 of 50 nm to 2 μm, where the average particle diameter D50 represents that 50% of particles in the porous ceramic layer have a particle diameter less than D50.

In an embodiment, wherein the inorganic particles of the porous ceramic layer include first inorganic particles having an average particle diameter (D50) of 50 to 500 nm and second inorganic particles having an average particle diameter (D50) of 500 to 2,000 nm, but the disclosed technology is not limited thereto.

In an embodiment, wherein the porous ceramic layer includes pores formed between the inorganic particles connected by a binder.

In an embodiment, wherein the porous substrate includes a polyolefin-based porous film.

In an embodiment, wherein the composite separator exhibits a thermal shrinkage of 3% or less in both a machine direction, in which the composite separator moves through a machine, and a transverse direction perpendicular to the machine direction, when measured at 150° C., but the disclosed technology is not limited thereto.

In another general aspect, a lithium secondary battery includes the composite separator based on an embodiment.

In another general aspect, a lithium secondary battery comprising a composite separator comprising an adhesive layer formed on an outermost layer of at least one surface of a porous separator, wherein the adhesive layer includes first organic particles with a first average particle diameter (D50) and a first glass transition temperature and second organic particles with a second average particle diameter (D50) and a second glass transition temperature, wherein an average particle diameter D50 represents that 50% of particles in the adhesive layer have a particle diameter less than D50, wherein the first glass transition temperature is lower than the second glass transition temperature, and the first average particle diameter is smaller than the second average particle diameter, and the first organic particles and the second organic particles satisfy the following Relational Expression 1:

$$3 \leq {T}_{2} / {T}_{1} \times {R}_{2} / {R}_{1} \leq 8.5 \qquad [ Relational Expression 1 ]$$

wherein T₁ is the first glass transition temperature in degrees Celsius (° C.), T₂ is the second glass transition temperature in degrees Celsius (° C.), R₁ is the first average particle diameter in micrometers (μm), and R₂ is the second average particle diameter in micrometers (μm).

In an embodiment, wherein the first glass transition temperature is 90° C. or lower, and the second glass transition temperature is 95° C. or higher, but the disclosed technology is not limited thereto.

In an embodiment, wherein the first average particle diameter ranges from 100 to 1,000 nm, and the second average particle diameter ranges from 500 to 2,000 nm, but the disclosed technology is not limited thereto.

In an embodiment, wherein the first glass transition temperature is 90° C. or lower and the first average particle diameter ranges from 100 to 1,000 nm, and the second glass transition temperature is 95° C. or higher and the second average particle diameter ranges from 500 to 2,000 nm, but the disclosed technology is not limited thereto, but the disclosed technology is not limited thereto.

In an embodiment, wherein a difference between the first glass transition temperature and the second glass transition temperature is 5° C. or higher, but the disclosed technology is not limited thereto.

In an embodiment, wherein the second average particle diameter is twice or more the first average particle diameter.

Other features and aspects will be apparent from the following detailed description, the drawings, and the claims.

### BRIEF DESCRIPTION OF THE DRAWINGS

FIG. 1 is a scanning electron microscope (SEM) image of a composite separator based on Example 1.

FIG. 2 is an SEM image of a composite separator based on Comparative Example.

FIG. 3 is a cross-sectional view of a composite separator based on an embodiment of the disclosed technology.

FIG. 4 is a cross-sectional view of a composite separator based on an embodiment of the disclosed technology.

### DETAILED DESCRIPTION OF EMBODIMENTS

Section headings are used in the present document only for ease of understanding and do not limit scope of the embodiments to the section in which they are described.

Hereinafter, some embodiments of the disclosed technology will be described in detail. However, the disclosed technology is not limited to specific embodiments.

One material parameter for a material formed of particles is the particle size distribution parameter DX of the particles in the material, where DX represents the particle size when the cumulative volume reaches X %, starting from the smallest particles. This means that X % of particles in the material have a particle diameter or size less than DX. For example, D80 represents a material in which 80% of the particles have a size less than D80; and D30 represents a material in which 30% of the particles has a size less than D30. The “average particle diameter (D50)” in the examples below refers to a particle diameter at which a volume cumulative percentage reaches 50% in a particle size distribution by the volume, i.e., 50% of particles by volume is a particle size less than D50.

In some embodiments of the disclosed technology, the term “average particle diameter” may be used to indicate “D50.” For example, the term “D50” may be used to indicate a particle diameter of inorganic particles and organic particles corresponding to 50% of a volume-based integration fraction as explained above. For example, the average particle diameter may be derived from particle size distribution results analyzed using S3500 available from Microtrac Retsch GmbH by collecting samples of the inorganic particles and organic particles to be measured in accordance with ISO 13320-1 standard. In some embodiments, the term “D90” refers to a particle diameter of particles corresponding to 90% of a volume-based integration fraction. For example, D90 refers to the particle diameter below which 90% of the particles in a sample fall. In some embodiments, the term “D10” refers to a particle diameter of inorganic particles and organic particles corresponding to 10% of a volume-based integration fraction. For example, D10 refers to the particle diameter at which 10% of the particles in a sample are smaller. In some embodiments, D90 and D10 may be derived in the same manner as in D50.

In some embodiments of the disclosed technology, the term “organic particle” refers to a particulate organic binder. In addition, to distinguish particles from those with different average particle diameters D50 and different glass transition temperatures, organic particles with a first average particle diameter and a first glass transition temperature are referred to as first organic particles and organic particles with a second average particle diameter and a second glass transition temperature are referred to second organic particles.

In some embodiments of the disclosed technology, the term “glass transition temperature (T_{g})” refers to a temperature range in which a glass transition occurs and may be measured using a dilatometer or a differential scanning calorimeter (DSC).

In some embodiments of the disclosed technology, the term “composite separator” refers to a structure that includes an adhesive layer formed on one or two opposite surfaces of a porous separator. In some embodiments of the disclosed technology, the “porous separator” may exist as a porous substrate itself or as a porous substrate with a porous ceramic layer (also referred to as a porous inorganic particle layer) on one surface or two opposite surfaces of the porous substrate. The porous ceramic layer may include pores formed between inorganic particles connected and fixed by a binder.

In some embodiments of the disclosed technology, “blocking” is measured by bringing two adhesive layers of a composite separator into contact. If an adhesive layer is present on only one surface of the composite separator, blocking is evaluated by stacking two composite separators with their adhesive layers facing each other, applying pressure of 1.7 MPa at 50° C. for 2 hours, and then peeling the adhesive layers apart at a speed of 300 mm/min at 180° angle. If an adhesive layer is present on two opposite surfaces of the composite separator, blocking is evaluated by selecting one of the two surfaces, bringing the adhesive layers into contact, applying pressure of 1.7 MPa at 50° C. for 2 hours, and then peeling the adhesive layers apart at a speed of 300 mm/min at 180° angle. In this case, the adhesive layers formed on the two opposite surfaces may have the same composition.

As explained above, a separator can be made of a porous substrate or a high heat-resistant separator including a porous substrate and a porous ceramic layer (or an inorganic particle layer) formed on one or both sides of the porous substrate. However, such a separator often lacks sufficient adhesion to an electrode. Consequently, the separator and electrode are often separated during a cell assembly process, leading to distortion or deformation of the electrode assembly. This issue can be problematic when the separator including the porous ceramic layer has insufficient adhesion to the electrode, because it can cause a misalignment between the electrode and the separator within a jelly roll during cell stacking.

When a misaligned stack cell battery operates, local resistance from misalignment or physical damage from continuous use can lead to a short circuit between electrodes, posing safety risks such as fire.

Moreover, with the increasing capacity and size of secondary batteries for applications such as electric vehicles, addressing these issues has become even more important. In certain ceramic-coated separators (CCS), where a porous ceramic (inorganic particle) layer is applied to one or both sides of a porous substrate, addressing these issues is especially important for vehicle batteries that require high capacity and heat resistance.

In an example, the adhesion between the separator and the electrode can enhanced by applying a solution containing an adhesive organic substance onto the surface of the separator in contact with the electrode, forming an adhesive layer upon drying. However, this organic adhesive reduces permeability, complicates film thinning, and still provides insufficient adhesion to the electrode.

Accordingly, when the separator is wound, the adhesive organic substance often transfers to the opposite surface and detaches, causing a blocking phenomenon. In addition, there can be additional issues, such as a decrease in ionic conductivity of the separator and/or a thickness deviation that occurs during alignment of the electrode assembly, which impair the performance of the battery.

As will be discussed below, the disclosed technology can be implemented in some embodiments to provide a separator that can address the above-discussed issues.

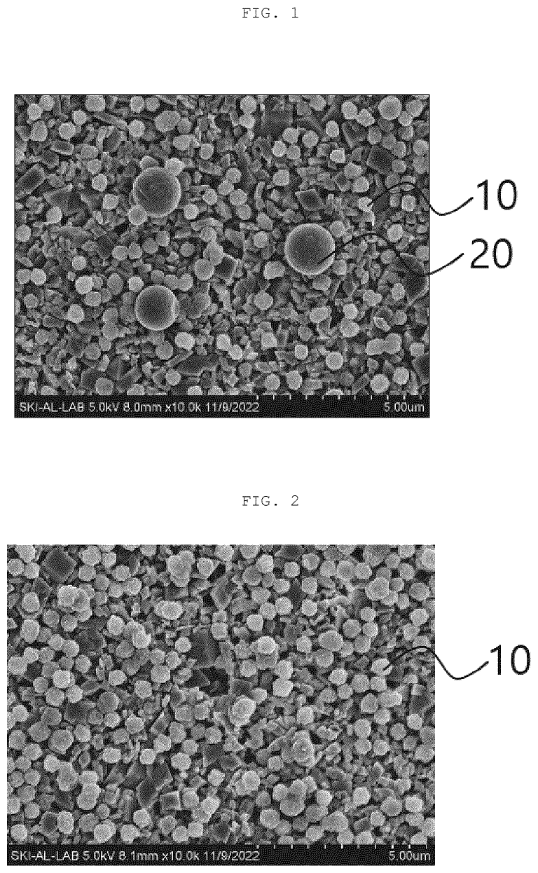

FIG. 1 is a scanning electron microscope (SEM) image of a composite separator based on an example. FIG. 2 is an SEM image of a composite separator based on a comparative example.

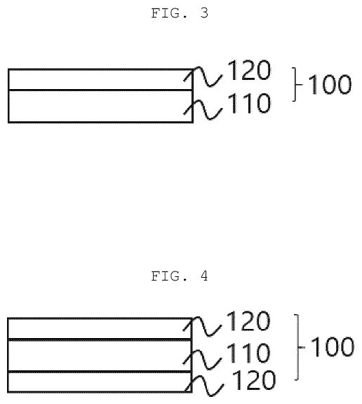

FIG. 3 is a cross-sectional view of a composite separator based on an embodiment of the disclosed technology. FIG. 4 is a cross-sectional view of a composite separator based on an embodiment of the disclosed technology.

As illustrated in FIGS. 3 and 4, in an embodiment of the disclosed technology, a composite separator 100 may include an adhesive layer 120 formed on one surface or two opposite surfaces of a porous separator 110 including a porous substrate or a porous ceramic layer (also referred to as a porous inorganic particle layer) formed on one surface or two opposite surfaces of the porous substrate and including pores formed between inorganic particles connected and fixed by a binder. The adhesive layer may include two or more types of organic particles having different average particle diameters (D50) and different glass transition temperatures.

In an embodiment of the disclosed technology, a composite separator may include an adhesive layer formed on the outermost layer of at least one surface of a porous separator. The adhesive layer may include first organic particles and second organic particles having different average particle diameters (D50) and different glass transition temperatures. The first organic particles have a lower glass transition temperature and a smaller average particle diameter than the second organic particles, and the first organic particles and the second organic particles satisfy the following Relational Expression 1:

$$3 \leq {T}_{2} / {T}_{1} \times {R}_{2} / {R}_{1} \leq 8.5 \qquad [ Relational Expression 1 ]$$

Here, T₁ is the glass transition temperature (° C.) of the first organic particles, T₂ is the glass transition temperature (° C.) of the second organic particles, R₁ is the average particle diameter D50 (μm) of the first organic particles, and R₂ is the average particle diameter D50 (μm) of the second organic particles.

As Relational Expression 1 is satisfied, blocking may be prevented during the winding of the composite separator into a roll, as well as during its storage and transport. In addition, this ensures better alignment during secondary battery assembly while simultaneously improving a capacity retention rate of the battery.

In an embodiment, the adhesive layer may be an adhesive layer including only the first organic particles and the second organic particles.

In an embodiment, the adhesive layer may be stacked to face a negative electrode and a positive electrode of a lithium secondary battery. That is, when a lithium secondary battery is assembled, the adhesive layer is stacked on the negative electrode or the positive electrode to exhibit an adhesion force.

In an embodiment, the areas of the porous substrate, the porous ceramic layer, and the adhesive layer may be substantially the same as or different from each other. For example, the porous ceramic layer may be formed on the porous substrate over the entire surface having the same area as that of the porous substrate, or may be formed having an area smaller than that of the porous substrate. In addition, the adhesive layer may be formed on the entire surface having the same area as that of the porous substrate or the porous ceramic layer, or may be formed having an area smaller than that of the porous substrate or the porous ceramic layer.

For example, the area of the formed adhesive layer may be 10 to 100% with respect to the total area of the porous ceramic layer or the porous substrate, and may be 99% or less, 95% or less, 90% or less, 80% or less, 70% or less, 60% or less, 50% or less, 40% or less, 30% or less, 20% or less, 10% or more, 20% or more, 50% or more, or between the above numerical values. For example, the area of the formed adhesive layer may be 10 to 90% or 20 to 80%, but is not limited as long as the object of the disclosed technology may be achieved.

In an embodiment, the porous ceramic layer may be formed to have a thickness of 1 to 50%, 1 to 45%, 1 to 40%, or 1 to 35% of the thickness of the entire composite separator. For example, the thickness of the porous ceramic layer may be 5 μm or less, 4 μm or less, 3 μm or less, 2 μm or less, 1 μm or less, 1 to 5 μm, or in any range between the above numerical values, but is not limited thereto.

In an embodiment, a coating amount of the adhesive layer may be 0.05 to 1.0 g/m², 0.1 to 0.8 g/m², 0.1 to 0.5 g/m², 0.1 to 0.3 g/m², or in any range between the above numerical values, but is not limited thereto. In an embodiment, the adhesive layer may be an adhesive layer in which the first organic particles and the second organic particles are attached to at least one surface of the porous separator in the above coating amount. In the coating amount, a weight is the sum of the weights of the first organic particles and the second organic particles, and may be measured after sufficiently drying.

In an embodiment, when the composite separator of the disclosed technology includes the adhesive layer including first organic particles and second organic particles having different average particle diameters D50 and different glass transition temperatures, the first organic particles have a lower glass transition temperature and a smaller average particle diameter than the second organic particles, and the first organic particles and the second organic particles satisfy Relational Expression 1, blocking does not occur between the adhesive layers. In a case where the occurrence of blocking between the adhesive layers was evaluated by the above method, when no blocking occurred, it was found that blocking was prevented even under severe conditions that occur during storage and transport after winding the composite separator, thereby completing the disclosed technology. For example, it can be confirmed that blocking does not occur even when the wound roll is stored at 50 to 70° C. for 7 days. The occurrence of blocking is evaluated by the method described in a measurement method described below. In addition, no blocking means that blocking is in a range where it is determined as OK or PASS in a blocking evaluation method described below.

$$3 \leq {T}_{2} / {T}_{1} \times {R}_{2} / {R}_{1} \leq 8.5 \qquad [ Relational Expression 1 ]$$

wherein T₁ is the glass transition temperature (C) of the first organic particles, T₂ is the glass transition temperature (° C.) of the second organic particles, R₁ is the average particle diameter D50 (μm) of the first organic particles, and R₂ is the average particle diameter D50 (μm) of the second organic particles.

In an embodiment, an adhesive force of the adhesive layer to a positive electrode may be 5 gf/cm or more, 6 gf/cm or more, 7 gf/cm or more, 8 gf/cm or more, 9 gf/cm or more, 10 gf/cm or more, 20 gf/cm or less, or in any range between the above numerical values. A higher adhesive force is preferable, but from the viewpoint of preventing blocking after winding and at the same time facilitating alignment during battery assembly, the adhesive force to the positive electrode may be 5 to 15 gf/cm. When the above range is satisfied, it may be more advantageous in providing an effect in which blocking does not occur not only at room temperature but also at 50 to 70° C.

The positive electrode is not limited, and may be formed of a positive electrode slurry prepared by adding lithium metal oxide including lithium-cobalt composite oxide (LiCoO₂), carbon black as a conductive agent, and polyvinylidene fluoride (PVDF) as a binder to N-methyl-2-pyrrolidone (NMP) as a solvent.

In an embodiment, an adhesive force of the adhesive layer to a negative electrode may be 2 gf/cm or more, 3 gf/cm or more, 4 gf/cm or more, 5 gf/cm or more, 6 gf/cm or more, 7 gf/cm or more, 15 gf/cm or less, or in any range between the above numerical values, but is not limited thereto.

The negative electrode is not limited, and may be formed of a negative electrode slurry prepared by adding lithium-intercalated material including artificial graphite, lithium, soft and hard carbon and silicon-based material, acrylic-based latex as a binder, and carboxymethyl cellulose as a thickener to water as a solvent.

The composite separator based on an embodiment of the disclosed technology may have a thermal shrinkage of 3% or less, 2% or less, 1.5% or less, 1% or less, or 0.5% or less when measured after being left at 150° C. for 1 hour, and as the composite separator has the above low thermal shrinkage, ignition or rupture due to abnormal phenomena such as a rapid temperature rise within the lithium secondary battery may be prevented.

In addition, a lithium secondary battery including the composite separator based on an embodiment of the disclosed technology may have a discharge capacity ratio of 90% or more, 95% or more, or 97% or more, the discharge capacity ratio being calculated by the following equation when a cycle evaluation is performed by charging and discharging the lithium secondary battery 300 times at a discharge rate of 1 C and then measuring a discharge capacity to determine a degree of decrease in capacity compared to an initial capacity based on an initial cell capacity of 1,800 mAh.

$$Discharge capacity ratio = ( Battery capacity measured after 300 cycles ) / Initial battery capacity$$

In addition, an adhesion of the composite separator may exhibit excellent adhesion. When electrodes are cut into pieces of 4 cm in width and 6 cm in length, and the four cut positive electrodes and four cut negative electrodes are alternately stacked on a surface of the composite separator based on an embodiment of the disclosed technology, heated and pressurized in a temperature atmosphere of 80° C. at 10 kgf/cm² for 30 seconds, and lifted vertically, there may be substantially no electrodes that fall.

In addition, in the disclosed technology, as for the property of non-blocking, when the composite separator including the ceramic layer and the adhesive layer is wound to 1,000 m or more and stored in an oven at each of 50° C. and 70° C. for 12 hours, and then the wound composite separator is unwound, there may be no inter-surface adhesion between the adhesive layers that are brought into contact with each other and no detachment of the ceramic layer.

Hereinafter, each component of the composite separator based on an embodiment of the disclosed technology will be described by way of example.

### [Porous Separator]

As an embodiment of the disclosed technology, the porous separator may be formed of a porous substrate, or may include a porous ceramic layer formed on one surface or both surfaces of a porous substrate and including inorganic particles.

The porous substrate may be a film, a sheet, or the like formed of a polyolefin-based resin, and may be used without limitation as long as it is a microporous film adopted in the related art. For example, the porous substrate is not particularly limited as long as it is a porous film that may be applied to a battery while having pores inside a non-woven fabric, paper, and a microporous film thereof or having pores with inorganic particles on a surface thereof.

The polyolefin-based resin may be a polyolefin-based resin alone or a mixture, and as a specific example, the polyolefin-based resin may be one or a mixture of two or more selected from polyethylene, polypropylene, and a copolymer thereof. In addition, the porous substrate may be manufactured using the polyolefin-based resin alone or using a polyolefin-based resin as a main component and additionally including inorganic particles or organic particles. In addition, the porous substrate may be used in a stacked form, for example, the porous substrate may be formed by constituting the polyolefin-based resin into multiple layers, and when the porous substrate is formed into multiple layers, one layer or all layers may include inorganic particles and organic particles in the polyolefin-based resin.

A thickness of the porous substrate is not particularly limited, and may be 5 to 30 μm. As the porous substrate, a porous substrate formed by stretching may be mainly adopted, but is not limited thereto.

The porous ceramic layer may have pores formed between the inorganic particles connected by a binder.

The binder may be included in an amount of 0.1 to 20 parts by weight, 0.1 to 10 parts by weight, or 1 to 5 parts by weight, with respect to 100 parts by weight of the inorganic particles, and may be used without limitation as long as it is a binder commonly used in the related art. As described above, as the binder is used in a significantly smaller amount than the inorganic particles, the porous ceramic layer has a structure in which inorganic particles are connected to each other and has pores formed by the inorganic particles being in surface contact with each other, thereby ensuring porosity.

Examples of the binder include various water-soluble and water-insoluble resins such as an acrylic-based resin such as polymethyl methacrylate and a copolymer thereof or polyacrylamide, an ester resin, polyamide, polyimide, a fluorine-based resin, polyacrylonitrile, polyethylene oxide, a cellulose-based resin, a polyvinyl alcohol-based resin, polyvinylpyrrolidone, an ethylene vinyl acetate copolymer, and cyanoethyl pullulan, and a mixture thereof, and the binder may be used in a form that is dissolved in a solvent or in the form of particles, but is not limited thereto.

The inorganic particles of the porous ceramic layer may be used without limitation as long as they are commonly used in the related art. For example, the inorganic particles may be one or two or more inorganic particles selected from alumina, boehmite, aluminum hydroxide, titanium oxide, barium titanium oxide, magnesium oxide, magnesium hydroxide, silica, clay, and glass powder, but are not limited thereto.

The inorganic particles may be included in an amount of 70 wt % or more and 99.5 wt % or less with respect to 100 wt % of the total weight of the porous ceramic layer. For example, the inorganic particles may be included in an amount of 70 wt % or more and 99 wt % or less, 70 wt % or more and 98 wt % or less, 80 wt % or more and 98 wt % or less, 85 wt % or more and 98 wt % or less, or 90 wt % or more and 98 wt % or less, but are not limited thereto. When the porous ceramic layer includes the binder and the inorganic particles in the contents described above, the pores of the porous ceramic layer may be secured, and an adhesion force between the porous substrate and the porous ceramic layer or between the inorganic particles may be secured.

An average particle diameter D50 of the inorganic particles is not limited, and may be, for example, 50 nm to 2 μm or 50 to 1,000 nm.

In an embodiment, the inorganic particles may be used by combining two types or two or more types of inorganic particles having different average particle diameters. For example, in the case of the two types of inorganic particles having different average particle diameters, an average particle diameter of first inorganic particles may be 50 to 500 nm or 100 to 400 nm, and an average particle diameter of second inorganic particles may be 500 to 2,000 nm or 600 to 1,000 nm.

In an embodiment, a thickness of the porous ceramic layer may be 5 μm or less, 4 μm or less, 3 μm or less, 2 μm or less, 1 μm or less, 1 to 5 μm, or in any range between the above numerical values, but is not limited thereto.

### [Adhesive Layer]

The adhesive layer of the disclosed technology may be formed on the outermost layer of at least one surface of the porous separator.

When the adhesive layer of the disclosed technology includes first organic particles and second organic particles having different average particle diameters D50 and different glass transition temperatures, the first organic particles have a lower glass transition temperature and a smaller average particle diameter than the second organic particles, and the first organic particles and the second organic particles satisfy Relational Expression 1, the object of the disclosed technology may be more easily achieved:

$$3 \leq {T}_{2} / {T}_{1} \times {R}_{2} / {R}_{1} \leq 8.5 \qquad [ Relational Expression 1 ]$$

Here, T₁ is the glass transition temperature (° C.) of the first organic particles, T₂ is the glass transition temperature (° C.) of the second organic particles, R₁ is the average particle diameter D50 (μm) of the first organic particles, and R₂ is the average particle diameter D50 (μm) of the second organic particles.

The composite separator including the adhesive layer based on the disclosed technology may achieve an effect in which blocking does not occur between the adhesive layers even at a high temperature, may prevent alignment defects during battery assembly, and, at the same time, may provide an excellent capacity retention rate of the battery.

In an embodiment, the first organic particles and the second organic particles may be used without limitation as long as they satisfy Relational Expression 1.

In an embodiment, the first organic particles and the second organic particles may have a swelling ratio of 300 to 500% based on the following Equation 1 when immersed in an electrolyte. When the swelling ratio is within the above range, it is advantageous in achieving the object of the disclosed technology, which is more preferable, but the swelling ratio is not limited thereto.

$$Swelling ratio = W 2 / W 1 \times 100 \qquad [ Equation 1 ]$$

W2 is a weight measured after immersed in the electrolyte, and W1 is a weight measured before immersed in the electrolyte.

In this case, the swelling ratio may be measured based on the measurement method of the examples described below. The electrolyte may be obtained by mixing ethylene carbonate, ethyl methyl carbonate, and dimethyl carbonate in a volume ratio of 3:5:2, and leaving them at 50° C. for 48 hours, the electrolyte was drained, and then, a weight of the organic particles was measured to calculate a rate of change in weight.

In an embodiment for satisfying Relational Expression 1, the first organic particles may have a glass transition temperature of 90° C. or lower, and the second organic particles may have a glass transition temperature of 95° C. or higher. For example, the first organic particles may have a glass transition temperature of 40 to 90° C., 40 to 85° C., 45 to 85° C., 45 to 70° C., 50 to 70° C., or 50 to 65° C., but are not limited thereto. The second organic particles may have a glass transition temperature of 95 to 150° C., 95 to 130° C., 95 to 110° C., or 100 to 110° C., but are not limited thereto.

In an embodiment, the first organic particles may have a lower glass transition temperature than the second organic particles, and the first organic particles and the second organic particles may have a glass transition temperature difference of 5° C. or higher. That is, the glass transition temperature of the second organic particles may be higher than that of the first organic particles by 5° C. or higher, 10° C. or higher, 20° C. or higher, 30° C. or higher, 35° C. or higher, 40° C. or higher, 45° C. or higher, 50° C. or higher, 55° C. or higher, 60° C. or higher, 100° C. or lower, 90° C. or lower, 80° C. or lower, 70° C. or lower, 65° C. or lower or in any range between the above numerical values. for example, 10 to 100° C., 10 to 90° C., 10 to 70° C., 30 to 70° C., 30 to 65° C., 30 to 60° C., 35 to 65° C., 40 to 60° C., 50 to 60° C., or 45 to 55° C., but is not limited thereto.

In an embodiment that satisfies Relational Expression 1, the first organic particles may have an average particle diameter of 100 to 1,000 nm, and the second organic particles may have an average particle diameter of 500 to 2,000 nm. For example, the first organic particles may have an average particle diameter of 100 to 1,000 nm, 200 to 800 nm, 200 to 600 nm, 300 to 700 nm, 400 to 600 nm or 500 to 600 nm, but are not limited thereto. The second organic particles may have an average particle diameter of 500 to 2,000 nm, 600 to 1,800 nm, 800 to 1,500 nm, 900 to 1,500 nm, 1,000 to 1,500 nm or 1,300 to 1,500 nm, but are not limited thereto. The average particle diameter refers to an average particle diameter defined as D50.

In an embodiment, the first organic particles may have a smaller average particle diameter than the second organic particles, and the average particle diameter of the second organic particles is twice or more the average particle diameter of the first organic particles. For example, a difference in the average particle diameter between the second organic particles and the first organic particles may be 100 to 2,000 nm, 200 to 1,500 nm, 300 to 1,500 nm, 300 to 1,100 nm, 600 to 1,100 nm or 400 to 900 nm, but is not limited thereto.

In an embodiment, the adhesive layer may be coated with the first organic particles and the second organic particles in a total content of 0.05 to 1.0 g/m², 0.1 to 0.8 g/m², 0.1 to 0.5 g/m², 0.2 to 0.4 g/m², or 0.1 to 0.3 g/m², but is not limited thereto.

In an embodiment, the first organic particles and the second organic particles may be included in the adhesive layer in a weight ratio (first organic particles:second organic particles) of 50 to 99:50 to 1, 55 to 95:45 to 5, 60 to 90:40 to 10, or 70 to 90:30 to 10, but are not limited thereto. Although not limited to the above range, as the content of the second organic particles having a large particle size and a relatively high glass transition temperature is set to be smaller than the content of the first organic particles, a binding force with the electrode may be ensured even at a low temperature, and binding to the porous ceramic layer may also be increased.

In an embodiment, the first organic particles and the second organic particles may be polymer particles that may be prepared by emulsion polymerization or suspension polymerization, and may be non-crosslinked or crosslinked particles. As an example, the first organic particles and the second organic particles may be organic particles formed of an acrylic-based polymer, a fluorine-based polymer, or a copolymer thereof. The first organic particles and the second organic particles may be particles formed of the same polymer or particles formed of different polymers.

Examples of the acrylic-based polymer include polymers obtained by polymerizing one or more monomers selected from C₁-C₁₀ alkyl (meth)acrylates; (meth)acrylates; (meth)acrylonitriles such as acrylonitrile and methacrylonitrile; aromatic vinyl monomers such as styrene, α-methylstyrene, styrenesulfonic acid, butoxystyrene, and vinylnaphthalene; and maleimide derivatives such as maleimide and phenylmaleimide. The acrylic-based polymer is not limited thereto and may be prepared by mixing various monomers.

For example, the first organic particle may be an acrylic-based copolymer obtained by copolymerizing a C₁-C₁₀ alkyl (meth)acrylate and a (meth)acrylonitrile. The (meth)acrylate refers to an acrylate or a methacrylate. Examples of the C₁-C₁₀ alkyl (meth)acrylate include, but are not limited to, methyl acrylate, methyl methacrylate, ethyl acrylate, ethyl methacrylate, butyl acrylate, and butyl methacrylate.

For example, the second organic particle may be an acrylic-based copolymer copolymerized using an aromatic vinyl monomer such as styrene and a monomer mixture including a C₁-C₁₀ alkyl (meth)acrylate, and the glass transition temperature may be increased by controlling a content of the aromatic vinyl monomer.

### [Method of Manufacturing Composite Separator]

Hereinafter, a method of manufacturing a composite separator of the disclosed technology will be described.

A method of manufacturing a composite separator for a secondary battery based on an embodiment of the disclosed technology includes applying an aqueous dispersion containing first organic particles and second organic particles onto one surface or both surfaces of a porous separator and drying the applied dispersion to form an adhesive layer.

In addition, the method of manufacturing a composite separator for a secondary battery based on an embodiment of the disclosed technology includes: a) applying a slurry containing inorganic particles and a binder onto one surface or both surfaces of a porous substrate and drying the applied slurry to form a porous ceramic layer; and b) applying an aqueous dispersion containing first organic particles and second organic particles onto one surface or both surfaces of a ceramic coated separator on which the porous ceramic layer is formed and drying the applied dispersion to form an adhesive layer. In a case that a porous separator is a porous substrate not containing the porous ceramic layer, the step a) may be omitted and the aqueous dispersion in the step b) may be applied onto one or both surface of the porous substrate.

Each component is the same as described above.

The slurry for forming the porous ceramic layer may be an aqueous slurry that uses water as a dispersion medium.

The dispersion for forming the adhesive layer may use water as a dispersion medium. The first organic particles and the second organic particles may be provided in the form of particles dispersed in water through emulsion or suspension polymerization.

As the coating method, any common method known in the related art may be applied without limitation, and non-limiting examples thereof include roll coating, spin coating, dip coating, bar coating, die coating, slit coating, inkjet printing, and a combination of these methods.

The drying step is not particularly limited, and a drying temperature may be 100° C. or lower, and may be, for example, 30 to 100° C. or 40 to 100° C. When the drying is performed at the above temperature, the coating layer may be dried uniformly without affecting the physical properties of the porous substrate, thereby preventing coating defects.

In addition, the method may include, after the drying, winding the composite separator into a roll and storing and transporting the wound separator.

### [Lithium Secondary Battery]

Another aspect of the disclosed technology provides a lithium secondary battery including the composite separator for a secondary battery described above. The lithium secondary battery may be manufactured by including the composite separator for a secondary battery based on an embodiment of the disclosed technology, a positive electrode, a negative electrode, and a non-aqueous electrolyte.

In an embodiment, the lithium secondary battery is manufactured by a general manufacturing method of arranging and assembling a negative electrode, a composite separator, and a positive electrode, and injecting an electrolyte. Therefore, the manufacturing method will not be described in detail herein.

In this case, the positive electrode, negative electrode, and non-aqueous electrolyte may be used without limitation as they are generally used in a lithium secondary battery.

In an embodiment, the positive electrode and negative electrode may be manufactured by mixing and stirring a positive electrode active material and a negative electrode active material with a solvent, and, as necessary, a binder, a conductive agent, a dispersant, and the like to prepare compositions, applying the compositions to current collectors formed of metal materials, drying the applied compositions, and then performing pressing. The positive electrode active material may be used as long as it is an active material commonly used in a positive electrode of a secondary battery. For example, lithium metal oxide particles containing one or two or more metals selected from the group consisting of Ni, Co, Mn, Na, Mg, Ca, Ti, V, Cr, Cu, Zn, Ge, Sr, Ag, Ba, Zr, Nb, Mo, Al, Ga, B, and a combination thereof may be used.

The negative electrode active material may be used as long as it is an active material commonly used in a negative electrode of a secondary battery. The negative electrode active material of the lithium secondary battery is preferably a material capable of lithium intercalation. As a non-limiting example, the negative electrode active material may be one or two or more materials selected from the group consisting of negative electrode active materials such as lithium (metal lithium), soft carbon, hard carbon, graphite, silicon, a Sn alloy, a Si alloy, a Sn oxide, a Si oxide, a T₁ oxide, a Ni oxide, an Fe oxide (FeO), and lithium-titanium oxide (LiTiO₂ or Li₄Ti₅O₁₂).

As the conductive agent, a common conductive carbon material may be used without particular limitation.

The non-aqueous electrolyte contains a lithium salt as an electrolyte and an organic solvent, and the lithium salt may be used without limitation as long as it is commonly used in an electrolyte for a lithium secondary battery and may be represented by Li⁺X⁻.

An anion of the lithium salt is not particularly limited, and one or two or more selected from F⁻, Cl⁻, Br⁻, I⁻, NO₃⁻, N(CN)²⁻, BF⁴⁻, ClO⁴⁻, PF⁶⁻, (CF₃)₂PF⁴⁻, (CF₃)₃PF³⁻, (CF₃)₄PF²⁻, (CF₃)₅PF⁻, (CF₃)₆P⁻, CF₃SO³⁻, CF₃CF₂SO³⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO³⁻, CF₃CO²⁻, CH₃CO²⁻, SCN⁻, and (CF₃CF₂SO₂)₂N⁻ may be used. As the organic solvent, one or a mixture of two or more selected from the group consisting of propylene carbonate, ethylene carbonate, diethyl carbonate, dimethyl carbonate, ethylmethyl carbonate, methylpropyl carbonate, dipropyl carbonate, dimethyl sulfoxide, acetonitrile, dimethoxyethane, diethoxyethane, sulfolane, γ-butyrolactone, and tetrahydrofuran may be used.

The non-aqueous electrolyte may be injected into an electrode structure composed of a positive electrode, a negative electrode, and a composite separator interposed between the positive electrode and the negative electrode.

An outer shape of the lithium secondary battery is not particularly limited, and may be selected from a cylindrical shape using a can, a square shape, a pouch shape, a coin shape, and the like.

Hereinabove, although the embodiments of the disclosed technology have been described in detail, it will be apparent to those skilled in the art to which the disclosed technology pertains that the disclosed technology may be variously modified without departing from the spirit and scope of the disclosed technology as disclosed in the accompanying claims. Therefore, changes in the embodiments of the disclosed technology are intended to fall within the scope of the disclosed technology.

Hereinafter, examples of the disclosed technology will be further described with reference to specific experimental examples. The examples and comparative examples included in the experimental examples are merely illustrative of the disclosed technology and do not limit the scope of the accompanying claims, it is obvious to those skilled in the art that various modifications and alterations may be made without departing from the spirit and scope of the disclosed technology, and it is obvious that these modifications and alterations are within the accompanying claims.

### 1. Adhesion Force to Electrode

Electrodes were cut into pieces of 4 cm in width and 6 cm in length, the four cut positive electrodes and four cut negative electrodes were alternately stacked on a surface of a composite separator, bonded in a temperature atmosphere of 80° C. at 10 kgf/cm² for 30 seconds, and unfolded, and then, the number of electrodes adhering to the composite separator was evaluated.

A: All 8 electrodes (4 anodes and 4 cathodes) remained adhered, B: 6 or 7 electrodes remained adhered, C: 4 or 5 electrodes remained adhered, D: fewer than 4 electrodes remained adhered

The positive electrode and negative electrode used in the evaluation were manufactured as follows.

Manufacture of positive electrode: A positive electrode slurry was prepared by adding 94 wt % of lithium-cobalt composite oxide (LiCoO₂) as a positive electrode active material, 3.5 wt % of carbon black as a conductive agent, and 2.5 wt % of polyvinylidene fluoride (PVDF) as a binder to N-methyl-2-pyrrolidone (NMP) as a solvent. The prepared slurry was applied to an aluminum (Al) thin film having a thickness of 30 μm, the applied slurry was dried at a temperature of 120° C., and then roll-pressing was performed, thereby manufacturing a positive electrode having a thickness of 150 μm.

Manufacture of negative electrode: A negative electrode mixed slurry was prepared by adding 95 wt % of artificial graphite, 3 wt % of a binder (acrylic-based latex having a T_{g} of −52° C.), and 2 wt % of a thickener (carboxymethyl cellulose (CMC)) to water as a solvent. The prepared slurry was applied to a copper (Cu) thin film having a thickness of 20 μm, the applied slurry was dried at a temperature of 120° C., and then roll-pressing was performed, thereby manufacturing a negative electrode having a thickness of 150 μm.

### 2. Blocking Test

Two samples were prepared, the adhesive layers were brought into contact with each other, pressurized at a temperature of 50° C. and a pressure of 1.7 MPa for 2 hours, and then peeled at a speed of 300 mm/min and 180°, and whether peeling of the coating layer between the adhesive layers occurred was evaluated. The occurrence of peeling of the coating layer in a 50×50 μm area was evaluated by observation with the naked eye and SEM.

PASS: When observing with the naked eye and confirming five random 50×50 μm areas over the entire area of the sample with SEM, no peeling of the coating layer occurs.

OK: When observing with the naked eye, no peeling of the coating layer is observed, and when confirming five random 50×50 μm areas over the entire area of the sample with SEM, less than 2% of the area of coating layer peeling is observed.

Fail: Even when observing with the naked eye, peeling of the coating layer is observed, or when confirming five random 50×50 μm areas over the entire area of the sample with SEM, 2% or more of the area of coating layer peeling is observed. If any of the five random areas shows more than 2% peeling, it is considered a fail.

### 3. Thermal Shrinkage

After leaving a separator with a size of 10 cm×10 cm at 150° C. for 1 hour, a rate of decrease in length was measured and a thermal shrinkage was calculated in both a machine direction and a width direction based on the following equation.

$$Thermal shrinkage ( \% ) = ( ( Length before heating - Length after heating ) / Length before heating ) \times 100$$

MD is a thermal shrinkage in a machine direction, and

TD is a thermal shrinkage in a transverse direction.

### 4. Increase in Permeability

An increase in permeability after forming the adhesive layer compared to the ceramic coated separator was calculated by measuring a Gurley permeability using the following equation.

$$Increase in permeabiliy = Permeability of coated separator after adhesive layer coating - Permeability of coated separator after ceramic coating$$

The Gurley permeability is measured based on ASTM D 726 standard using a densometer available from Toyo Seiki Seisaku-sho, Ltd. (TOYOSEIKI), and the time taken for 100 cc of air to pass through an area of 1 in² of the separator is recorded in seconds. A unit of the Gurley permeability is see/100 cc.

### 5. Battery Lifespan Discharge Capacity Ratio Compared to Initial Capacity

A pouch-type battery was assembled using the same stacking method as in the evaluation of the adhesion force to the electrode, each assembled battery was subjected to heat pressing at 80° C. and 10 kgf/cm² for 30 seconds before electrolyte injection, and an electrolyte obtained by mixing ethylene carbonate (EC), ethyl methyl carbonate (EMC), and dimethyl carbonate (DMC) in a volume ratio of 3:5:2 and M lithium containing 1 hexafluorophosphate (LiPF₆) dissolved therein was injected, thereby manufacturing a lithium secondary battery.

Each of the manufactured batteries was subjected to a cycle evaluation by charging and discharging the battery 300 times at a discharge rate of 1 C, and then measuring a discharge capacity to measure a degree of decrease in capacity compared to an initial capacity.

$$Discharge capacity ratio = ( Battery capacity measured after 300 cycles ) / Initial battery capacity ( 1.8 Ah )$$

### 6. Method of Measuring Average Particle Diameter

An average particle diameter D50 for the inorganic particles and the particulate binder was measured using a particle size analyzer, S3500 available from Microtrac Retsch GmbH, based on the ISO 13320-1 standard.

### 7. Method of Measuring Glass Transition Temperature (T_{g})

Analysis was performed by a differential scanning calorimeter (DSC) (DSC-822E available from Mettler Toledo). As analysis conditions, the solvent was removed, 5 mg of a solidified sample was heated from −50° C. to 200° C. at a scanning rate of 10° C./min under nitrogen conditions to completely melt the sample, cooled at 10° C./min to solidify the sample, and heated again at 10° C./min in a range of −50° C. to 200° C., and then, a glass transition temperature was measured. T_{g} was determined as the inflection point where the curve changes significantly in the DSC graph.

### 8. Thickness (μm)

A thickness of the separator was determined by the following method. The separators were stacked in 10 layers, thicknesses were measured at five random points selected along a transverse direction using a thickness gauge available from Mitutoyo Corporation, and the measured thicknesses were added up and divided by 5 to derive an average thickness of the 10 layers of the separators. The obtained value was divided by 10 again to derive an average thickness of the entire single separator.

### Example 1

1) Manufacture of Ceramic Coated Separator (Porous Separator Coated with Porous Ceramic Layer)

The following slurry for an inorganic particle layer was coated using a bar coater at a speed of 5 m/min onto both surfaces of a polyethylene porous substrate (ENPASS available SK Innovation Co., Ltd.) having a Gurley permeability of 126 sec/100 cc and a thickness of 9 μm to form a coating layer, and the coating layer was sufficiently dried at 40° C. to form a porous ceramic layer. After drying, a coating thickness of the porous ceramic layer formed on each of the surfaces was 1.5 μm.

The slurry for an inorganic particle layer was mixed with 29.1 wt % of boehmite particles having an average particle diameter (D50) of 300 nm and 67.9 wt % of boehmite particles having an average particle diameter (D50) of 700 nm as inorganic particles, and 3 wt % of a polyacrylamide resin, and water as a solvent was added and stirred, thereby preparing a composition having a solid content concentration of 25 wt %.

### 2) Manufacture of Composite Separator

A coating solution for an adhesive layer was coated using a bar coater at a speed of 5 m/min onto both surfaces of the ceramic coated separator to form an adhesive layer, and the adhesive layer was dried sufficiently at 40° C. and then wound into a roll shape. A thickness of the adhesive layer formed on each of the surfaces was 0.5 μm, and a coating amount on each of the surfaces was 0.3 g/m².

As the coating solution for an adhesive layer, a mixture was used, the mixture obtained by mixing a first organic particle dispersion of 17.5 g (an acrylic-based polymer using butyl methacrylate, methyl methacrylate, and acrylonitrile as monomers, D50: 300 nm, T_{g}: 40° C., solid content: 40 wt %) and a second organic particle dispersion of 15 g (an acrylic-based polymer using styrene and methyl methacrylate as monomers, D50: 900 nm, T_{g}: 100° C., solid content: 20 wt %). A solid content in the entire solution was 70:30 (first organic particles: second organic particles) in terms of weight ratio.

The physical properties of the manufactured composite separator were evaluated. The results are shown in Table 1. In addition, the surface was observed and illustrated in FIG. 1. As illustrated in FIG. 1, it was confirmed that the first organic particles 10 and the second organic particles 20 were evenly distributed.

### Examples 2 to 9

Composite separators were manufactured in the same manner as that of Example 1, except that the type or content of organic particles in the coating solution for an adhesive layer was changed as shown in Table 1.

The physical properties of the manufactured composite separator were evaluated. The results are shown in Table 1.

### Comparative Examples 1 to 4

Composite separators were manufactured in the same manner as that of Example 1, except that the coating solution for an adhesive layer was changed as shown in Table 2.

The physical properties of the manufactured composite separator were evaluated. The results are shown in Table 2.

TABLE 1

| | Example | Example | Example | Example | Example | Example | Example | Example | Example |
|---|---|---|---|---|---|---|---|---|---|
| | 1 | 2 | 3 | 4 | 5 | 6 | 7 | 8 | 9 |
| T₁ (° C.) | 40 | 40 | 50 | 55 | 55 | 65 | 65 | 65 | 60 |
| T₂ (° C.) | 100 | 102 | 110 | 105 | 110 | 110 | 110 | 110 | 95 |
| R₁ (nm) | 300 | 300 | 400 | 600 | 600 | 400 | 400 | 400 | 200 |
| R₂ (nm) | 900 | 1000 | 1500 | 1500 | 1000 | 1500 | 1300 | 1300 | 1000 |
| Relational Expression | 7.5 | 8.5 | 8.3 | 4.8 | 3.3 | 8.25 | 5.5 | 5.5 | 7.9 |
| 1 | | | | | | | | | |
| Weight ratio of first | 70:30 | 70:30 | 70:30 | 70:30 | 70:30 | 70:30 | 90:10 | 50:50 | 70:30 |
| organic | | | | | | | | | |
| particles:second | | | | | | | | | |
| organic particles | | | | | | | | | |
| Adhesion force to | A | A | A | A | A | A | A | B | B |
| electrode | | | | | | | | | |
| Blocking test results | OK | OK | Pass | Pass | Pass | Pass | Pass | Pass | Pass |
| Thermal shrinkage at | 1.5/1.5 | 1.5/1.5 | 1.5/1.5 | 1.5/1.5 | 1.5/1.5 | 1.5/1.5 | 1.5/1.5 | 1.5/1.5 | 1.5/1.5 |
| 150° C. | | | | | | | | | |
| MD/TD | | | | | | | | | |
| Increase in | 19 | 18 | 15 | 8 | 8 | 15 | 11 | 5 | 14 |
| permeability after | | | | | | | | | |
| adhesive layer coating | | | | | | | | | |
| (s) | | | | | | | | | |
| Battery lifespan | 89 | 90 | 92 | 95 | 89 | 92 | 93 | 90 | 92 |
| discharge capacity | | | | | | | | | |
| ratio compared to | | | | | | | | | |
| initial capacity (%) | | | | | | | | | |

As shown in Table 1, it was confirmed that the adhesion force to the electrode was excellent and the anti-blocking properties were excellent as Relational Expression 1 was satisfied. In addition, even after forming the adhesive layer, it was confirmed that the increase in permeability was 20 seconds or shorter, which was lower than the permeability of the ceramic coated separator, and it was confirmed that the battery lifespan discharge capacity ratio compared to the initial capacity was 85% or more, which was excellent.

TABLE 2

| | Comparative | Comparative | Comparative | Comparative |
|---|---|---|---|---|
| | Example 1 | Example 2 | Example 3 | Example 4 |
| T₁ (° C.) | 65 | — | 50 | 70 |
| T₂ (° C.) | — | 110 | 90 | 95 |
| R₁ (nm) | 400 | — | 200 | 600 |
| R₂ (nm) | — | 1300 | 1000 | 900 |
| Relational | — | — | 9 | 2 |
| Expression 1 | | | | |
| Weight ratio of | 100:0 | 0:100 | 70:30 | 70:30 |
| first organic | | | | |
| particles:second | | | | |
| organic | | | | |
| particles | | | | |
| Adhesion force | A | C | C | B |
| to electrode | | | | |
| Blocking test | Fail | Pass | OK | Fail |
| results | | | | |
| Thermal | 1.5/1.5 | 1.5/1.5 | 1.5/1.5 | 1.5/1.5 |
| shrinkage at | | | | |
| 150° C. | | | | |
| MD/TD | | | | |
| Increase in | 15 | 5 | 25 | 14 |
| permeability | | | | |
| after adhesive | | | | |
| layer coating | | | | |
| (s) | | | | |
| Battery lifespan | 85 | 80 | 76 | 77 |
| discharge | | | | |
| capacity ratio | | | | |
| compared to | | | | |
| initial capacity | | | | |
| (%) | | | | |

As shown in Table 2, in the case where Relational Expression 1 did not satisfy the range of the disclosed technology, the adhesive force and the anti-blocking properties were not satisfied at the same time, and the lifespan of the battery was significantly reduced.

As shown in Comparative Example 1, in the case where the second organic particles were not used, the adhesive force was exhibited, but there was a problem of the occurrence of blocking.

As shown in Comparative Example 2, in the case where only the second organic particles having a glass transition temperature higher than 80° C., which is an adhesion process temperature, were included in the adhesive layer, it was confirmed that the adhesive force was not exhibited.

As shown in Comparative Example 3, in the case where Relational Expression 1 did not satisfy the range of the disclosed technology, the adhesive force was not exhibited, and insufficient improvement in blocking.

As shown in Comparative Example 4, in the case where Relational Expression 1 did not satisfy the range of the present disclosure, the adhesive force was at level B, and blocking occurred.

As set forth above, the composite separator based on an embodiment of the disclosed technology has an excellent adhesive force to the electrode, and may minimize or prevent the blocking phenomenon that may occur during winding.

As discussed above, the disclosed technology can be implemented in some embodiments to provide a separator that exhibits excellent heat resistance, small thermal shrinkage, and excellent battery stability.

As discussed above, the disclosed technology can be implemented in some embodiments to provide a separator with excellent adhesive force to an electrode, as its adhesive force remains stable even after being wound, unwound, and used.

As discussed above, the disclosed technology can be implemented in some embodiments to provide a composite separator that may minimize or prevent the peeling off of a coating layer caused by a blocking phenomenon, even when exposed to a high temperature during storage and transport of a wound separator. Specifically, it is possible to provide a composite separator having excellent anti-blocking properties, minimizing or preventing blocking between adhesive layers, between an adhesive layer and a ceramic layer, or between an adhesive layer and a porous substrate, in a wound roll, even when stored at a high temperature of 50 to 70° C. as well as at room temperature of about 25° C. during transport and storage of a wound separator.

As discussed above, the disclosed technology can be implemented in some embodiments to provide a composite separator that minimizes or prevents blocking when adhesive layers of the separator implemented based on some embodiments of the disclosed technology are brought into contact with each other, pressurized at a temperature of 50° C. and a pressure of 1.7 MPa for 2 hours, and then peeled at a speed of 300 mm/min and an angle of 180°.

As discussed above, the disclosed technology can be implemented in some embodiments to provide a battery with excellent electrode-to-separator alignment within a jelly roll during cell stacking, minimizing or preventing misalignment during a process and ensuring a uniform thickness deviation.

As discussed above, the disclosed technology can be implemented in some embodiments to provide a battery that may exhibit uniform lithium ion conductivity across the entire area of a separator and may maintain a capacity retention rate of 85% or more, 90% or more, or 95% or more after 300 cycles compared to an initial capacity.

The disclosed technology can be implemented in making rechargeable secondary batteries, secondary battery packs or assemblies that are widely used in battery-powered devices or systems, including, e.g., digital cameras, mobile phones, notebook computers, hybrid vehicles, electric vehicles, uninterruptible power supplies, battery storage power stations, and others including battery power storage for solar panels, wind power generators and other green tech power generators. Specifically, the disclosed technology can be implemented in some embodiments to provide improved electrochemical devices such as a battery pack used in various power sources and power supplies, thereby mitigating climate changes in connection with uses of power sources and power supplies. Battery packs based on the disclosed technology can be used to address various adverse effects such as air pollution and greenhouse emissions by powering electric vehicles (EVs) as alternatives to vehicles using fossil fuel-based engines and by providing battery-based energy storage systems (ESSs) to store renewable energy such as solar power and wind power.

Only specific examples of implementations of certain embodiments are described. Variations, improvements and enhancements of the disclosed embodiments and other embodiments may be made based on the disclosure of this patent document.

What is claimed is:

1. A composite separator for a secondary battery, the composite separator comprising a porous separator, and an adhesive layer formed on an outermost layer of at least one surface of the porous separator,
wherein the adhesive layer includes first organic particles with a first average particle diameter (D50) and a first glass transition temperature and second organic particles with a second average particle diameter (D50) and a second glass transition temperature,
wherein the first glass transition temperature is lower than the second glass transition temperature, and the first average particle diameter is smaller than the second average particle diameter, and
the first organic particles and the second organic particles satisfy the following Relational Expression 1:
$$3 \leq {T}_{2} / {T}_{1} \times {R}_{2} / {R}_{1} \leq 8.5 \qquad [ Relational Expression 1 ]$$
wherein T₁ is the first glass transition temperature in degrees Celsius (° C.), T₂ is the second glass transition temperature in degrees Celsius (° C.), R₁ is the first average particle diameter in micrometers (μm), and R₂ is the second average particle diameter in micrometers (μm).

2. The composite separator of claim 1, wherein the first glass transition temperature is 90° C. or lower, and the second glass transition temperature is 95° C. or higher.

3. The composite separator of claim 1, wherein the first average particle diameter ranges from 100 to 1,000 nm, and the second average particle diameter ranges from 500 to 2,000 nm.

4. The composite separator of claim 1, wherein the first glass transition temperature is 90° C. or lower and the first average particle diameter ranges from 100 to 1,000 nm, and
the second glass transition temperature is 95° C. or higher and the second average particle diameter ranges from 500 to 2,000 nm.

5. The composite separator of claim 1, wherein a difference between the first glass transition temperature and the second glass transition temperature is 5° C. or higher.

6. The composite separator of claim 1, wherein the second average particle diameter is twice or more the first average particle diameter.

7. The composite separator of claim 1, wherein a content ratio of the first organic particles to the second organic particles calculated based on weight ranges from 50:50 to 99:1.

8. The composite separator of claim 1, wherein the first organic particles and the second organic particles include acrylic-based organic particles.

9. The composite separator of claim 1, wherein the porous separator includes a porous substrate or a porous ceramic layer, wherein the porous ceramic layer is formed on one surface or two opposite surfaces of a porous substrate and includes inorganic particles.

10. The composite separator of claim 9, wherein the inorganic particles of the porous ceramic layer have an average particle diameter D50 of 50 nm to 2 μm, where the average particle diameter D50 represents that 50% of particles in the porous ceramic layer have a particle diameter less than D50.

11. The composite separator of claim 10, wherein the inorganic particles of the porous ceramic layer include first inorganic particles having an average particle diameter (D50) of 50 to 500 nm and second inorganic particles having an average particle diameter (D50) of 500 to 2,000 nm.

12. The composite separator of claim 9, wherein the porous ceramic layer includes pores formed between the inorganic particles connected by a binder.

13. The composite separator of claim 9, wherein the porous substrate includes a polyolefin-based porous film.

14. The composite separator of claim 1, wherein the composite separator exhibits a thermal shrinkage of 3% or less in both a machine direction, in which the composite separator moves through a machine, and a transverse direction perpendicular to the machine direction, when measured at 150° C.

15. A lithium secondary battery comprising a composite separator comprising an adhesive layer formed on an outermost layer of at least one surface of a porous separator,
wherein the adhesive layer includes first organic particles with a first average particle diameter (D50) and a first glass transition temperature and second organic particles with a second average particle diameter (D50) and a second glass transition temperature,
wherein the first glass transition temperature is lower than the second glass transition temperature, and the first average particle diameter is smaller than the second average particle diameter, and
the first organic particles and the second organic particles satisfy the following Relational Expression 1:
$$3 \leq {T}_{2} / {T}_{1} \times {R}_{2} / {R}_{1} \leq 8.5 \qquad [ Relational Expression 1 ]$$
wherein T₁ is the first glass transition temperature in degrees Celsius (° C.), T₂ is the second glass transition temperature in degrees Celsius (° C.), R₁ is the first average particle diameter in micrometers (μm), and R₂ is the second average particle diameter in micrometers (μm).

16. The lithium secondary battery of claim 15, wherein the first glass transition temperature is 90° C. or lower, and the second glass transition temperature is 95° C. or higher.

17. The lithium secondary battery of claim 15, wherein the first average particle diameter ranges from 100 to 1,000 nm, and the second average particle diameter ranges from 500 to 2,000 nm.

18. The lithium secondary battery of claim 15, wherein the first glass transition temperature is 90° C. or lower and the first average particle diameter ranges from 100 to 1,000 nm, and
the second glass transition temperature is 95° C. or higher and the second average particle diameter ranges from 500 to 2,000 nm.

19. The lithium secondary battery of claim 15, wherein a difference between the first glass transition temperature and the second glass transition temperature is 5° C. or higher.

20. The lithium secondary battery of claim 15, wherein the second average particle diameter is twice or more the first average particle diameter.
